(19) United States
(12) Patent Application Publication
(10) Pub. No.: US 2005/0183000 A1
(43) Pub. Date: Aug. 18, 2005

(54) Method for remarking image taken by digital camera

(76) Inventor: Pu-Hua Mei, Taipei Hsien (TW)

Correspondence Address: SUPREME PATENT SERVICES, POST OFFICE BOX 2339, SARATOGA, CA, 95070, US

(21) Appl. No.: 10/779,348

(22) Filed: Feb. 14, 2004

(51) Int. Cl. G06F 17/00

(52) U.S. Cl. 715/500.1; 715/501.1

(57) ABSTRACT

A method for remarking image taken by digital camera involves an image-sensing element, a sound-sensing element, a logic element, and an output element. The method is performed through the logic element to edit video/audio signals caught by the image-sensing element and the sound-sensing element into a link file in the format compatible with a web browser. At this moment, a plurality of image data and corresponding remarking sound data are assigned and stored at once, so that a user can view a selected image data and listen to a corresponding remarking sound data synchronously when the link file is opened by the web browser.

### BACKGROUND OF THE INVENTION

1. Field of the Invention

The present invention relates to a method for remarking image taken by digital camera by editing a link file in a data format readable by a web browser through a logic element whereby a user is allowed to view the image taken and synchronously remarking sound thereof.

2. The Prior Arts

A generic digital camera is supposed to meanwhile record and embed a piece of sound data as remarks in a specific format into a piece of image taken, so that a user may fetch the sound data directly or download the video image to a computer and open it to listen to the remarking sound.

Besides, a digital camera of some species may store the image and sound data in different respective files such that a user may open the image file and fetch the sound data, however, in this case, a special tool will be needed for treating the image data downloaded.

### SUMMARY OF THE INVENTION

As mentioned, in the method for remarking image taken by digital camera, the sound data is embedded in the image data, and both the image and the sound data are organized in a specific format which is usually incompatible with the application program of a generic digital camera or computer, a user would be troubled to install another application program capable of reading data in that format.

Therefore, a method of the present invention for remarking image taken by digital camera is provided to use a language compatible with that of a web browser to thereby eliminate the said inconvenience.

The method of the present invention involves an image-sensing element, a sound-sensing element, a logic element, and an output element, and is performed through a step for sensing an image source and a sound signal by an image-sensing element and a sound-sensing element respectively; a step for the logic element to store the respective video and audio signals as image and sound data; a step for the logic element to edit a link file in HTML format to thereby assign and display the image data and sound data stored at once when a web browser opens the link file; and a step for the output element to store or output the link file in HTML format edited by the logic element, and/or store or output the related image data and sound data.

In short, the merits of the method of the present invention may be summarized in the following respects:
(1) As a language compatible with that of a web browser is applied in the present invention for editing a file linked with an image and its remarking sound data, hence, it is possible for a user to open this link file through the web browser for viewing the image data and listening to the remarking sound data.
(2) A link file comprised of the image data and the remarking sound data can be opened by a web browser without needing any extra application software so as to promote its availability and circulation.
(3) Because the link file comprised of the image data and the remarking sound data is of a text file format, it only occupies several KB of a digital camera's memory.
(4) In case the sound data is taken as a main storage target, the corresponding image data may serve for a remarking data reversely.

For more detailed information regarding advantages or features of the present invention, at least an example of preferred embodiment will be described below with reference to the annexed drawings.

### BRIEF DESCRIPTION OF THE DRAWINGS

The related drawings in connection with the detailed description of the present invention to be made later are described briefly as follows, in which:

FIG. 1 shows the configuration of elements in accordance with the method of the present invention for remarking image taken by a digital camera; and

FIG. 2 shows a flowchart of the method for remarking image taken by a digital camera.

### DETAILED DESCRIPTION OF THE BEST MODE FOR CARRYING OUT THE PRESENT INVENTION

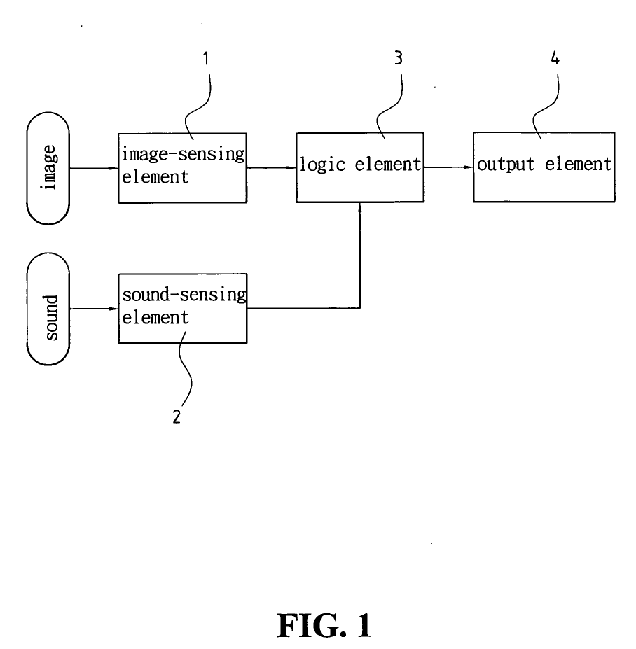

FIG. 1 shows the configuration of elements in accordance with the method of the present invention for remarking image taken by a digital camera. As shown in FIG. 1, in a digital camera, the method of the present invention involves an image-sensing element (1) for detecting video signals, a sound-sensing element (2) for detecting audio signals, a logic element (3) for logic operation or edition of detected video or audio signals, and an output element (4) for storing or outputting the data sent out from the logic element (3).

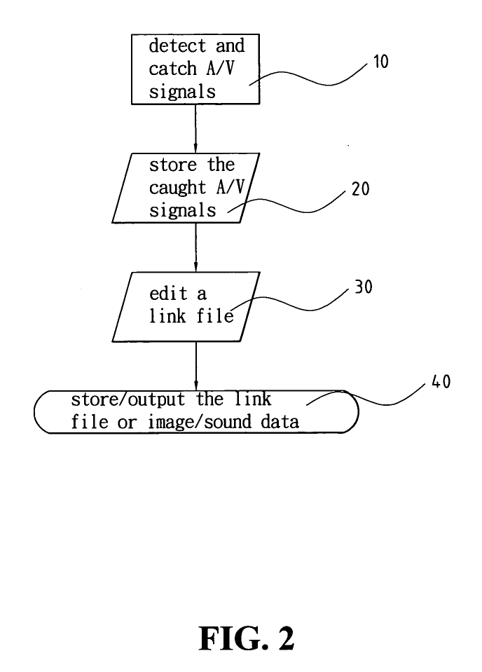

The flowchart shown in FIG. 2 includes the following steps:

Step 10 is a step for the image-sensing element (1) and the sound-sensing element (2) to detect and catch video and audio signals, respectively.

Step 20 is a step for the logic element (3) to store the caught video/audio signals in step 10.

Step 30 is a step for the logic element (3) to edit a link file in HTML (Hyper Text Markup Language) format for assigning and displaying the image/sound data stored at once by opening the link file through a web browser.

Step 40 is a step for storing or outputting the link file edited in HTML format and/or the image/sound data through the logic element (3).

In step 30, any language other than above-mentioned, such as Java or Javascript, is also applicable for editing a text file as long as it is readable by the web browser.

The information of the link file in HTML format edited by the logic element (3) is comprised of image and sound data taken at once, so that a user is enabled to view the related image data and listen to the remarking sound data synchronously through a digital camera or by opening the link file with a web browser after download of the image and sound data to a computer through the output element (4).

Moreover, it is possible for a user to assign a plurality of image data and link them with respective sound data at a time so that he/she can view several image data in the same link file and locate to listen to the sound data corresponding to the selected image data.

Similar to the way the sound data being recorded and replayed, simple text record related to picture-taking may be edited in the link file for synchronous display with the image data afterwards, in which the text record could be a picture-taking date, various photographic settings, or some input text information.

In the above described, at least one preferred embodiment has been described in detail with reference to the drawings annexed, and it is apparent that numerous changes or modifications may be made without departing from the true spirit and scope thereof, as set forth in the claims below.

1. A method for remarking image taken by digital camera, comprising the following steps:
(1) detecting and catching video/audio signals with an image-sensing element and a sound-sensing element, respectively;
(2) storing the caught video-audio signals with a logic element;
(3) editing a link file in HTML (Hyper Text Markup Language) format with the logic element for assigning and displaying the image/sound data stored at once by opening the link file through a web browser; and
(4) selectively storing and outputting the link file edited in HTML format and/or the image/sound data through the logic element.

2. The method according to claim 1, wherein the link file is edited with a language compatible with that of the web browser.

3. The method according to claim 2, wherein the language compatible to the web browser is Java.

4. The method according to claim 2, wherein the language compatible to the web browser is Javascript.

5. The method according to claim 1, wherein the logic element is capable of assigning and editing a plurality of image data into the link file, and linking a plurality of corresponding sound data with those image data, respectively, so that a user can listen to the corresponding sound data by selecting an arbitrary image data while the link file is opened.

6. The method according to claim 1, wherein the image data of the link file are linked with text data so that the text data is displayed when the link file is opened.
